(19) United States
(12) Patent Application Publication
(10) Pub. No.: US 2005/0240739 A1
(43) Pub. Date: Oct. 27, 2005

(54) Memory devices signaling task completion and interfaces and software and methods for controlling the same

(75) Inventor: Alberto Pesavento, Seattle, WA (US)

Correspondence Address: THELEN REID & PRIEST LLP;IMPJ, P.O. BOX 640640, SAN JOSE, CA, 95164-0640, US

(73) Assignee: Impinj. Inc., a Delaware Corporation

(21) Appl. No.: 10/833,907

(22) Filed: Apr. 27, 2004

(51) Int. Cl. G06F 12/00

(52) U.S. Cl. 711/156

(57) ABSTRACT

Memory devices have cells for storing data, and transmit a completion signal when a task is completed. Interfaces, software and methods use the completion signal to control such memory devices. In one embodiment, an interface asserts a continuous task signal on the memory, and deasserts it when it senses the completion signal. In one embodiment, a memory discontinues the completion signal when the task signal is deasserted. RFID tags according to the invention include a memory device that transmits a completion signal to an interface. The interface may be external to the RFID tag, or also hosted on it.

### FIELD OF THE INVENTION

The present invention is related to the field of memory devices that store data, and interfaces and software and methods for controlling such memory devices.

### BACKGROUND

Memory devices, such as those made from semiconductors, are used for many applications. Operations of these memory devices, such as writing and reading data, take place at ever increasing speeds. Such speeds are becoming important to enable Radio Frequency IDentification (RFID) applications of memories.

Tasks should be performed one at a time in a memory device, to prevent conflict. Each of the tasks requires a certain time to be performed. Different types of tasks require different amounts of time. And even tasks of the same type may require different amounts of time. An application controlling a memory typically allots for each task the maximum time that its type could take, to prevent conflict. Accordingly, when a task actually spends less time than the maximum allotted, time is wasted. It is desirable to minimize such waste.

### BRIEF SUMMARY

The invention improves over the prior art.

Briefly, the present invention provides memory devices with cells for storing data. The invention also provides interfaces, software and methods to control such memory devices.

In one embodiment, when a task is completed, a memory device transmits a completion signal. Upon receiving the completion signal, an interface can control the memory to start the next task quickly afterwards. Conflict is avoided, because the completion signal provides benchmarking.

In some embodiments, an RFID tag includes a memory device that transmits a completion signal to an interface. The interface may be external to the RFID tag, or also hosted on it.

The invention offers the advantage that there is less delay between successive tasks, than if the maximum amount of time had been allotted for a task of a certain type. Indeed, an interface controlling the memory need not wait the maximum time before starting the next task.

In one embodiment, the memory device includes an internal polling mechanism for enabling the completion signal to be transmitted. In some embodiments, the polling mechanism is the same for different types of tasks. In that case, the invention offers the additional advantage that the same completion signal can be used even for different types of tasks. This way time need not be allotted at all, not even for tasks of different types.

These and other features and advantages of the invention will be better understood from the specification of the invention, which includes the following Detailed Description and accompanying Drawings.

### BRIEF DESCRIPTION OF THE DRAWINGS

The following Detailed Description proceeds with reference to the accompanying Drawings, in which:

FIG. 1A is a block diagram showing a memory device interacting with an interface.

FIG. 1B is a block diagram showing an RFID tag that includes a memory device.

FIG. 1C is a block diagram showing an RFID tag that includes a memory device and an interface.

FIG. 2 is a block diagram showing an embodiment of elements of a memory device.

FIG. 3 is a block diagram showing a first possible implementation of an internal polling mechanism for completion indicators of FIG. 2.

FIG. 4A is a block diagram showing a second possible implementation of an internal polling mechanism for completion indicators of FIG. 2.

FIG. 4B is a schematic diagram of one embodiment of a gate of FIG. 4A.

FIG. 4C is a schematic diagram of one embodiment of a gate of FIG. 4A.

FIG. 5 is a diagram illustrating signaling between the blocks of FOG. 1A.

FIG. 6 is a timing diagram illustrating signaling for the performance of tasks.

FIG. 7 is a timing diagram showing sample detailed signals during the performance of an initializing task of the memory of FIG. 1A;.

FIG. 8 is a timing diagram showing sample detailed signals during the performance of a programming task of the memory of FIG. 1A.

FIG. 9 is a timing diagram showing sample detailed signals during the performance of a program verification task of the memory of FIG. 1A.

FIG. 10 is a timing diagram showing sample detailed signals during the performance of a reading task of the memory of FIG. 1A.

FIG. 11 is a flowchart illustrating a memory device method.

FIG. 12 is a flowchart illustrating an interface and software method, all according to embodiments of the present invention.

### DETAILED DESCRIPTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on.

Accordingly, the present invention may take the form of an entirely hardware embodiment, an entirely software embodiment or an embodiment combining software and hardware aspects. The following detailed description is, therefore, not to be taken in a limiting sense.

As has been mentioned, the present invention provides devices with cells for storing data and which signal when a task is completed. The invention also provides interfaces, software and methods that sense the signaling to control such memory devices. The invention is now described in more detail.

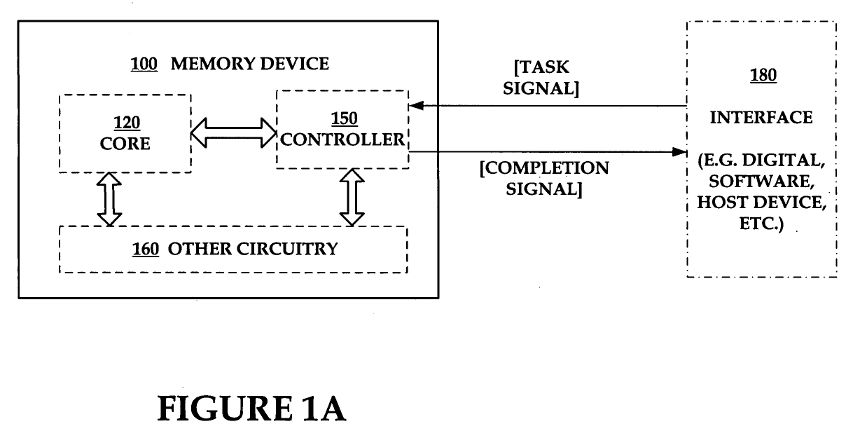

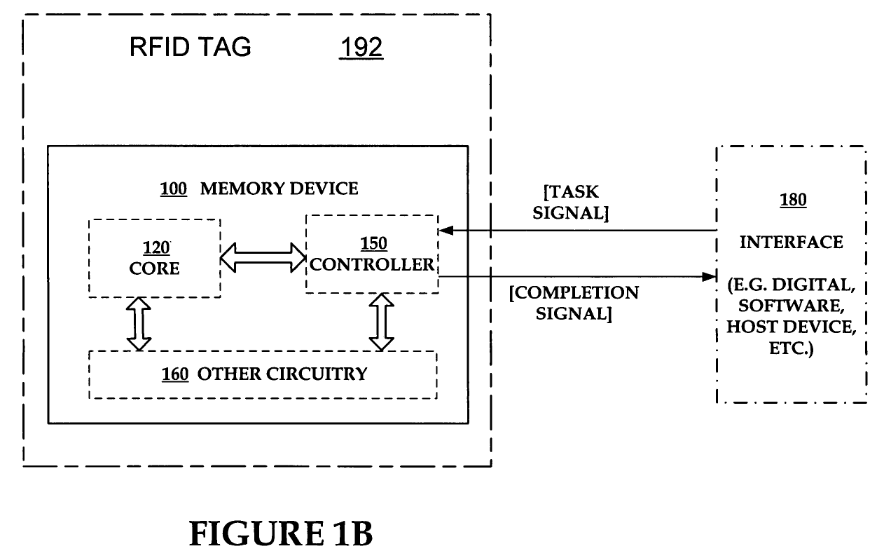

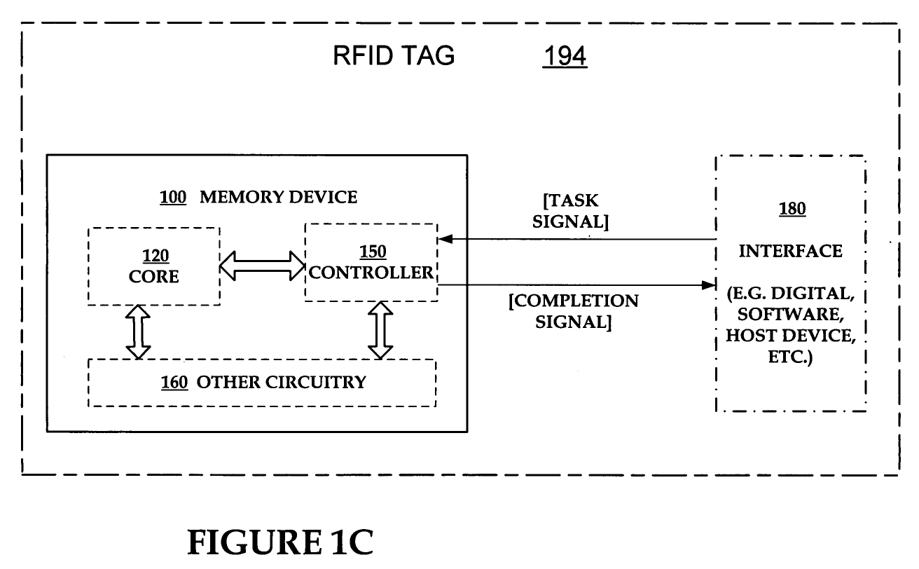

FIG. 1A is a block diagram showing a memory device 100 and an interface 180, both made according to embodiments of the invention. In FIG. 1A, device 100 interacts with interface 180, as is preferred. In addition, device 100 may interact with interfaces that are not made according to the invention, and interface 180 may interact with memory devices that are not made according to the invention

In general, interface 180 may be used to control memory device 100 by exchanging signals with it as is known in the art, and further as will be described in more detail below. Interface 180 may be implemented in any number of ways according to the invention. It may be either a standalone component, or parts of it may be distributed on different components. One of those components may even be located in memory device 100. As will be described in more detail below, in some embodiments of the invention, memory device 100 is part of an RFID tag. In those cases, interface 180 may be off the RFID tag, or hosted on, such as being part of an integrated circuit.

In general, interface 180 may be implemented in software, hardware or both. Interface 180 may be implemented such that it is adapted for automatic use by a machine, such as an operating machine or a testing apparatus. Alternately, interface 180 may be implemented such that it is adapted for use by a human operator, e.g. including an input port, an output port, and so on.

Memory device 100 includes a core 120 suitable for storing data, a controller 150 for controlling operations of core 120 and communicating with interface 180, and other circuitry 160. These elements are discussed in more detail below.

In operation, interface 180 asserts a task signal to memory device 100. The task signal relates to a task associated with at least one of the cells in core 120, and possibly the data stored in the cells. Controller 150 receives the task signal, and performs the task. Then controller 150 transmits a completion signal that is associated with performing the task. Interface 180 receives the completion signal, and proceeds with another task, by asserting another task signal and so on. This exchange of signals will be described in more detail below.

RFID embodiments of the invention are now described. In general, Radio Frequency IDentification (RFID) tags can be used in many ways for locating and identifying objects that they are attached to. RFID tags are particularly useful in product-related and service-related industries for tracking large numbers of objects are being processed, inventoried, or handled. In such cases, an RFID tag is usually attached to individual items, or to their packages.

In principle, RFID techniques entail using a device called an RFID reader to interrogate one or more RFID tags. Interrogation is performed by the reader transmitting a Radio Frequency (RF) wave. A tag that senses the interrogating RF wave responds by transmitting back another RF wave, a process known as backscatter. The response may further encode a number stored internally in the tag. The response, and the number if available, is decoded by the reader, which thereby identifies, counts, or otherwise interacts with the associated item. The number can denote a serial number, a price, a date, a destination, other attribute(s), any combination of attributes, and so on.

An RFID tag includes an antenna system, a radio section, a logical section, and a memory. Advances in semiconductor technology have miniaturized the electronics so much that an RFID tag can generate the backscatter while powered by only the RF signal it receives, enabling some RFID tags to operate without a battery.

FIG. 1B is a block diagram showing an RFID tag 192 that includes memory device 100 according to embodiments of the invention. Tag 192 communicates with external interface 180.

FIG. 1C is a block diagram showing an RFID tag 194 that includes memory device 100 and also interface 180. Accordingly, many or all of the actions described in this document take place within tag 194. Interface 180 may be formed advantageously as part of the same integrated circuit (IC) as memory device 100, in which case many or all of the actions described in this document take place within the IC.

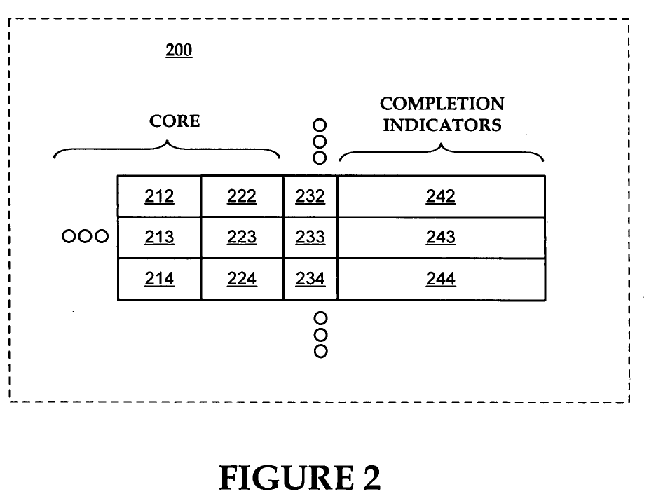

FIG. 2 is a block diagram showing an embodiment of elements of a memory device 200 according to the invention, which could be made similarly to device 100. Device 200 includes memory cells 212, 222, 213, 223, 214, 224, . . . for storing data, which are made in any way known in the art. In some embodiments, memory cells 212, 222, 213, 223, 214, 224, . . . include transistors that may store an electrical charge, such as on an isolated gate. An example of such a transistor is mentioned in U.S. Pat. No. 5,627,392, and related patents. In one of those embodiments, a cell may include a pair of such transistors. In addition, memory cells 212, 222, 213, 223, 214, 224, . . . may be advantageously arranged along addressable lines, such as rows and columns.

Device 200 also includes peripheral components 232, 233, 234 for controlling memory cells 212, 222, 213, 223, 214, 224, . . . , as also directed by interface 180. Components 232, 233, 234 may include I/O buffers, and other components known in the art. Components 232, 233, 234 may be suited to control groups of cells that are part of a respective addressable lines.

Device 200 also includes completion indicators 242, 243, 244. Each one of completion indicators 242, 243, 244 is associated with at least one of the memory cells, or possibly a group of them. In the embodiment of device 200, each one of completion indicators 242, 243, 244 is associated with the cells that belong in an addressable line, whether it is a row or a column.

Completion indicators 242, 243, 244 become set when a task is performed on their associated cells. In one embodiment, the task type may be initializing, programming, program verification, commanding read, erasing or testing the associated cells. In one of those embodiments, one of the cells may include a pair of transistors, and the task of initializing may be performed by substantially equalizing a charge stored in the transistors. In some of these embodiments, the completion signal is the same for two or more of the different task types. This is preferably accomplished having the polling mechanism be the same for two or more different ones of the task types.

It will be apparent that the invention is capable of many implementations, especially when comparing device 200 with device 100 in FIG. 1A. For example, peripheral components 232, 233, 234 and/or completion indicators 242, 243, 244 of device 200 may be implemented as either part of core 120, or as part of controller 150.

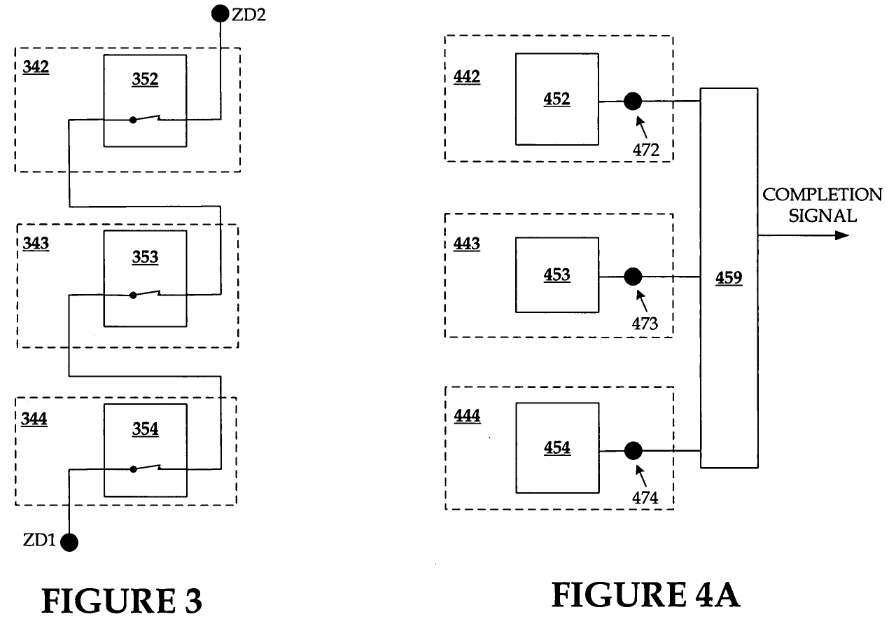

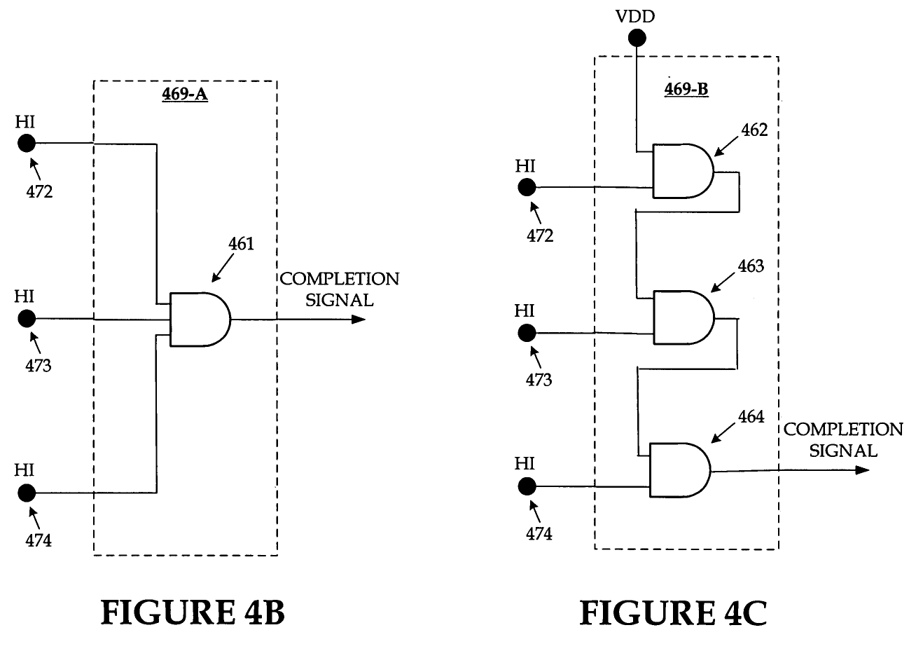

In addition, device 200 includes an internal polling mechanism (not shown in FIG. 2), which generates the completion signal that is transmitted to the interface. The completion signal is generated when at least some of completion indicators 242, 243, 244 are set. The polling mechanism involves the design of completion indicators 242, 243, 244, and will be described in more detailed below with reference to FIG. 3 and FIG. 4.

FIG. 3 is a block diagram showing a first possible implementation of the polling mechanism. Completion indicators 342, 343, 344 are coupled in series, which is also known as being daisy chained. In the embodiment of FIG. 3, completion indicators 342, 343, 344 include respective switches 352, 353, 354. Switches 352, 353, 354, as well as other switches in this description, may be made from switching circuits such as transistors. These, as well as other transistors in this description, may include MOSFETs (Metal Oxide Semiconductor Field Effect Transistor) that include nFETs and pFETs, jFETs (junction FETs), BJTs (bipolar junction transistors), MESFETs (MEtal Semiconductor FETs), FinFETs (fin FETs), HBTs (Heterojunction Bipolar Transistors), IGFETs (Insulated Gate Transistors), TFTs (Thin Film Transistors), and so on.

In the embodiment of FIG. 3, completion indicators 342, 343, 344 become set by closing respective switches 352, 353, 354. The polling mechanism tests a series impedance of the coupled completion indicators 342, 343, 344, such as between nodes ZD1 and ZD2. The series impedance may be tested by a voltage or a current. In one embodiment, the series impedance is tested by asserting a high voltage at node ZD1. If all switches 352, 353, 354 become closed, a high voltage appears at node ZD2, which may further advantageously be treated as the completion signal.

FIG. 4A is a block diagram showing a second possible implementation of the polling mechanism. Completion indicators 442, 443, 444 have respective main nodes 472, 473, 474. Completion indicators 442, 443, 444 become set by applying preset voltages to respective main nodes 472, 473, 474. The polling mechanism further includes a gate 459 that inputs the voltages of main nodes 472, 473, 474, and outputs the completion signal. In one embodiment, completion indicators 442, 443, 444 include respective latches 452, 453, 454 to apply the preset voltages at main nodes 472, 473, 474, respectively.

FIG. 4B is a schematic of a circuit 469-A, which is one embodiment of gate 459 of FIG. 4A. Circuit 469-A includes a triple input AND gate 461, which receives the voltages on main nodes 472, 473, 474. In this embodiment, the preset voltages are a logical HI, for gate 461 to output the completion signal.

FIG. 4C is a schematic of a circuit 469-B, which is another embodiment of gate 459 of FIG. 4A. Circuit 469-B includes three AND gates 462, 463, 464, one for each of nodes 472, 473, 474 respectively. In this embodiment, the preset voltages are a logical HI, for gate 464 to output the completion signal.

For both the embodiments of FIG. 3 and FIG. 4A, setting of completion indicators is described. Part of the design involves reversing the setting, in anticipation of the next task, and so on.

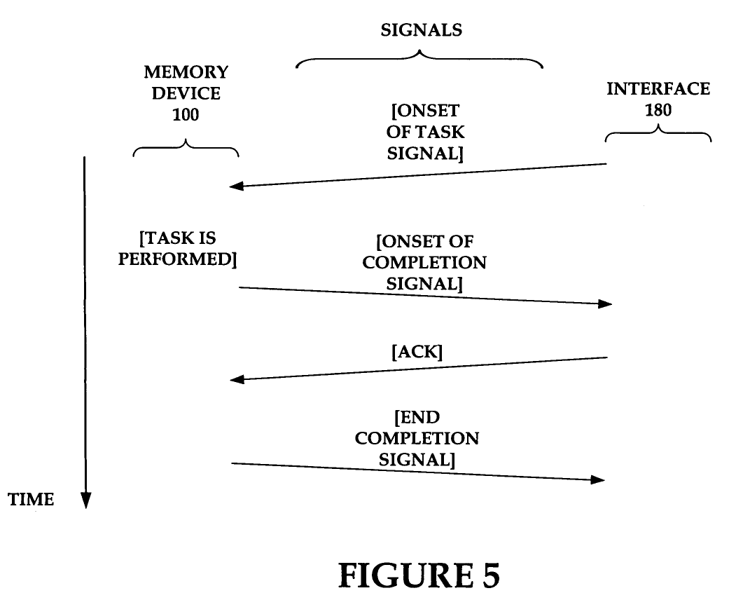

FIG. 5 is a diagram illustrating signaling between memory device 100 and interface 180 of FIG. 1A according to an embodiment of the invention. A task signal is asserted from interface 180 to memory device 100. The task signal may be considered any signal for that purpose, such as a task control signal, a data signal, an address signal and so on. In the preferred embodiment, the task signal is a task control signal that is applied continuously while memory device 100 performs the task. Then memory device 100 transmits a completion signal in association with performing the task. If the task signal is a task control signal that is applied continuously while the task is being performed, then an onset of the completion signal is transmitted while the task signal is still being asserted.

Interface 180 uses the completion signal to infer when the task is completed. In general, the completion signal may be transmitted some time before the task has been completed. In one embodiment, the completion signal has a preset duration, and the inference is made also from the duration. In the preferred embodiment, however, an onset of the completion signal in transmitted right after the task has been completed, in which case inferring by interface 180 is trivial.

In some embodiments, interface 180 is adapted to transmit acknowledgement signaling (e.g. signal ACK), in response to either the completion signal, or having inferred that the task has been completed and when. In one of those embodiments, memory device 100 is further adapted to discontinue transmitting the completion signal, when it receives signal ACK.

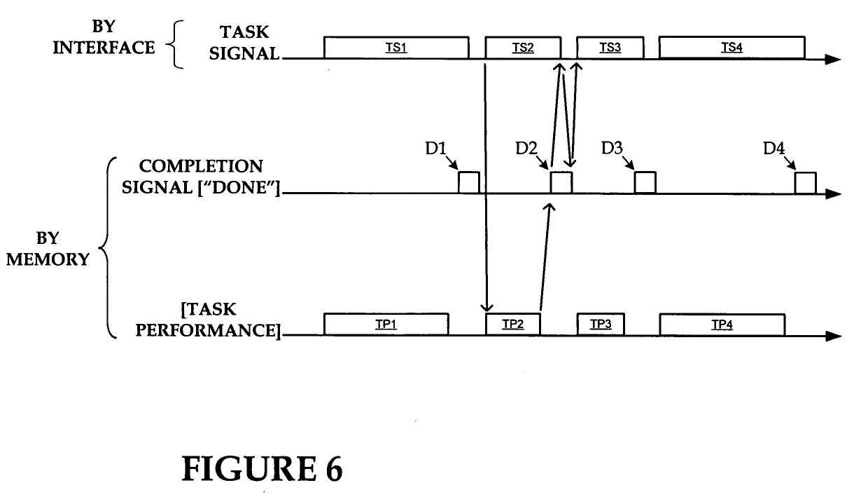

FIG. 6 is a timing diagram illustrating signaling for the performance of tasks. Four task signals TS1, TS2, TS3, TS4 are generated by interface 180, and transmitted to memory device 100. These cause memory device 100 to perform four respective tasks TP1, TP2, TP3, TP4, and to denote the completion of each of them with respective completion signals (“DONE”) D1, D2, D3, D4. It will be appreciated that wasted time (between performing tasks on the lowest axis) is minimized.

In the embodiment of FIG. 6, task control signals TS1, TS2, TS3, TS4 are applied continuously, while the respective tasks are being performed.

In one embodiment, interface 180 uses the received completion signal as an inhibit signal, to prevent from asserting the next task signal prematurely. In that case, it waits to assert the second task signal until receiving the completion signal is discontinued. Accordingly, interface 180 transmits acknowledgement signaling when it is ready for the completion signal to be discontinued. In embodiments where the onset of the completion signal indicates the completion of the first task and readiness for the second task, acknowledgement signaling may be issued upon the onset of the completion signal.

Acknowledgement signaling may be implemented by discontinuing the transmission of the task signal. Accordingly, memory device 100 may deem to have received acknowledgement signaling when it stops receiving the task signal.

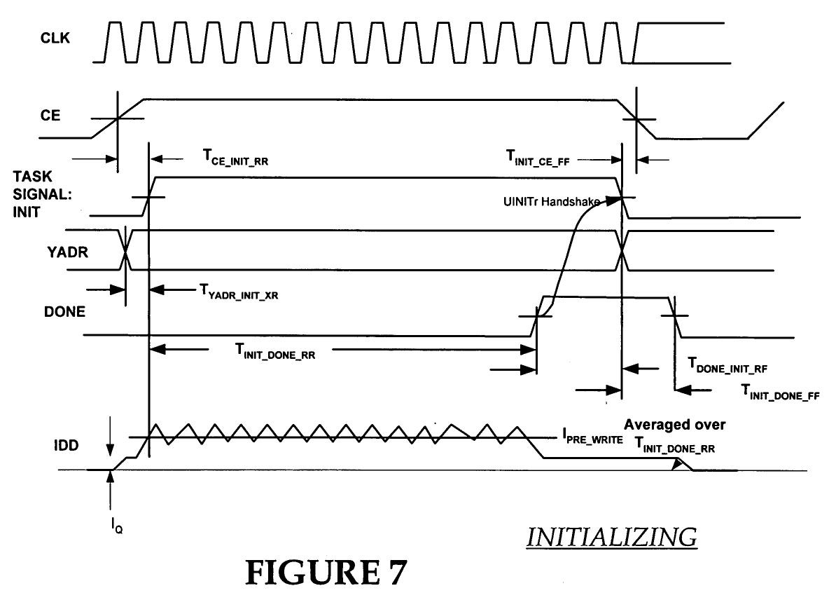

FIG. 7 is a timing diagram showing sample detailed signals during the performance of an initializing task of memory device 100. The task signal is task control signal INIT that is applied continuously until completion signal DONE signal has been discontinued.

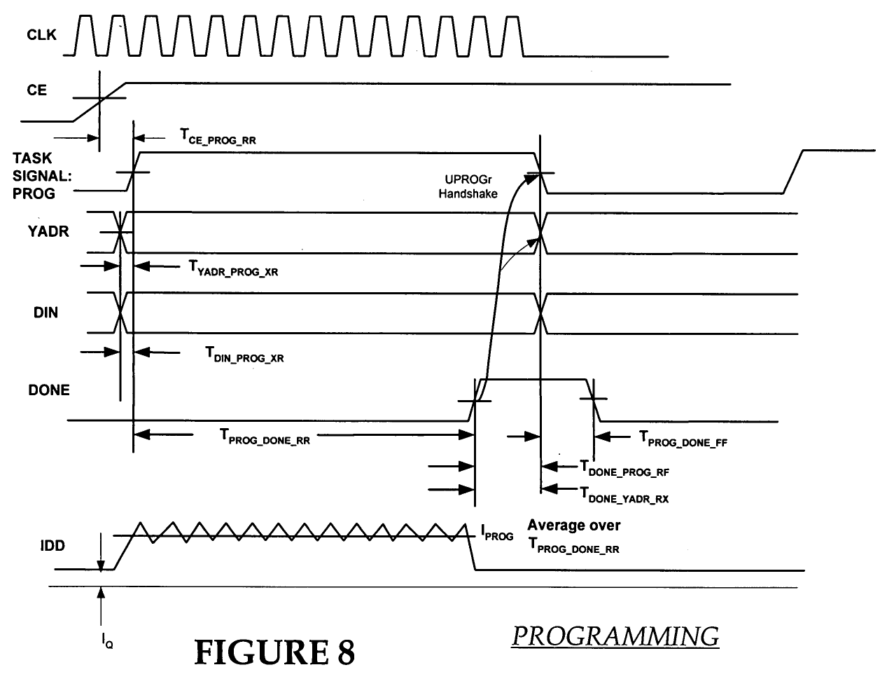

FIG. 8 is a timing diagram showing sample detailed signals during the performance of a programming task of memory device 100. The task signal is task control signal PROG that is applied continuously until completion signal DONE signal has been discontinued.

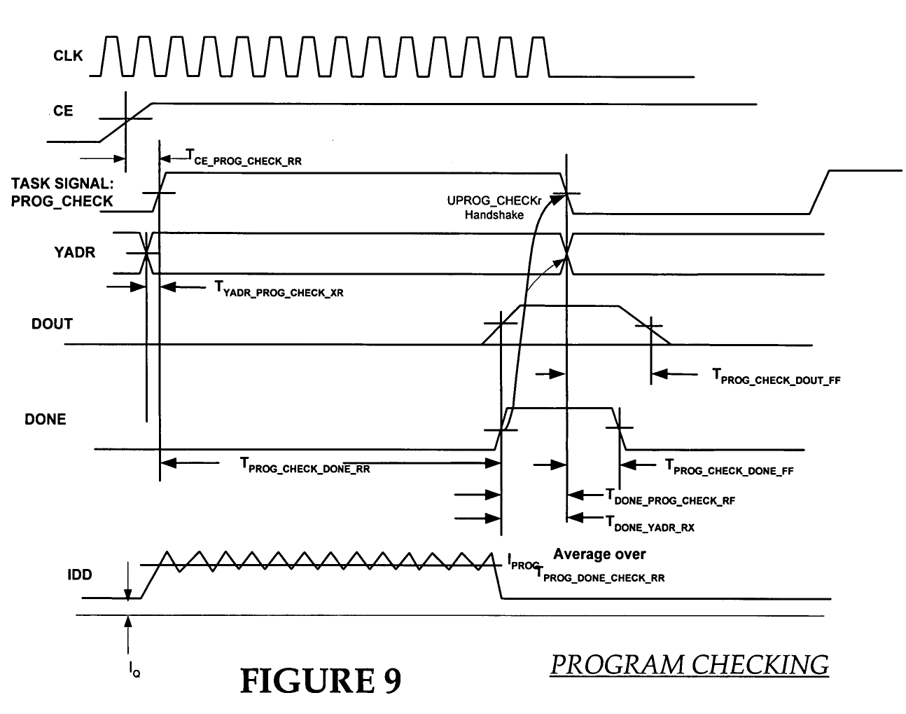

FIG. 9 is a timing diagram showing sample detailed signals during the performance of a program verification task of memory device 100, which is also known as program checking and program check. The task signal is task control signal PROG_CHECK that is applied continuously until completion signal DONE signal has been discontinued.

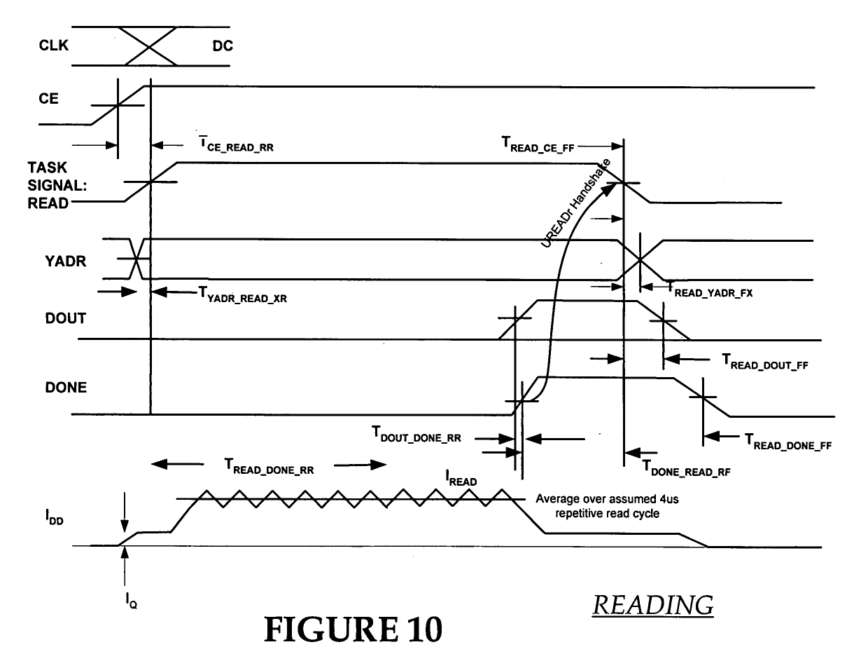

FIG. 10 is a timing diagram showing sample detailed signals during the performance of a reading task of memory device 100. The task signal is task control signal READ that is applied continuously until completion signal DONE signal has been discontinued.

Other tasks are also possible, such as erasing and testing and so on.

The present invention may be implemented by one or more devices that include logic circuitry. The device performs functions and/or methods as are described in this document. The logic circuitry may include a processor that may be programmable for a general purpose, or dedicated, such as microcontroller, a microprocessor, a Digital Signal Processor (DSP), etc. For example, the device may be a digital computer like device, such as a general-purpose computer selectively activated or reconfigured by a computer program stored in the computer. Alternately, the device may be implemented an Application Specific Integrated Circuit (ASIC), etc.

Moreover, the invention additionally provides methods, which are described below. The methods and algorithms presented herein are not necessarily inherently associated with any particular computer or other apparatus. Rather, various general-purpose machines may be used with programs in accordance with the teachings herein, or it may prove more convenient to construct more specialized apparatus to perform the required method steps. The required structure for a variety of these machines will become apparent from this description.

In all cases there should be borne in mind the distinction between the method of the invention itself and the method of operating a computing machine. The present invention relates both to methods in general, and also to steps for operating a computer and for processing electrical or other physical signals to generate other desired physical signals.

The invention additionally provides programs, and methods of operation of the programs. A program is generally defined as a group of steps leading to a desired result, due to their nature and their sequence. A program made according to an embodiment of the invention is most advantageously implemented as a program for a computing machine, such as a general-purpose computer, a special purpose computer, a microprocessor, etc.

The invention also provides storage media that, individually or in combination with others, have stored thereon instructions of a program made according to the invention. A storage medium according to the invention is a computer-readable medium, such as a memory, and is read by the computing machine mentioned above.

The steps or instructions of a program made according to an embodiment of the invention requires physical manipulations of physical quantities. Usually, though not necessarily, these quantities may be transferred, combined, compared, and otherwise manipulated or processed according to the instructions, and they may also be stored in a computer-readable medium. These quantities include, for example electrical, magnetic, and electromagnetic signals, and also states of matter that can be queried by such signals. It is convenient at times, principally for reasons of common usage, to refer to these quantities as bits, data bits, samples, values, symbols, characters, images, terms, numbers, or the like. It should be borne in mind, however, that all of these and similar terms are associated with the appropriate physical quantities, and that these terms are merely convenient labels applied to these physical quantities, individually or in groups.

This detailed description is presented largely in terms of flowcharts, display images, algorithms, and symbolic representations of operations of data bits within at least one computer readable medium, such as a memory. An economy is achieved in the present document in that a single set of flowcharts is used to describe both methods of the invention, and programs according to the invention. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Often, for the sake of convenience only, it is preferred to implement and describe a program as various interconnected distinct software modules or features, individually and collectively also known as software. This is not necessary, however, and there may be cases where modules are equivalently aggregated into a single program with unclear boundaries. In any event, the software modules or features of the present invention may be implemented by themselves, or in combination with others. Even though it is said that the program may be stored in a computer-readable medium, it should be clear to a person skilled in the art that it need not be a single memory,.or even a single machine. Various portions, modules or features of it may reside in separate memories, or even separate machines. The separate machines may be connected directly, or through a network, such as a local access network (LAN), or a global network, such as the Internet.

It will be appreciated that some of these methods may include software steps which may be performed by different modules of an overall parts of a software architecture. For example, data forwarding in a router may be performed in a data plane, which consults a local routing table. Collection of performance data may also be performed in a data plane. The performance data may be processed in a control plane, which accordingly may update the local routing table, in addition to neighboring ones. A person skilled in the art will discern which step is best performed in which plane.

In the present case, methods of the invention are implemented by machine operations. In other words, embodiments of programs of the invention are made such that they perform methods of the invention that are described in this document. These may be optionally performed in conjunction with one or more human operators performing some, but not all of them. As per the above, the users need not be collocated with each other, but each only with a machine that houses a portion of the program. Alternately, some of these machines may operate automatically, without users and/or independently from each other.

Methods of the invention are now described.

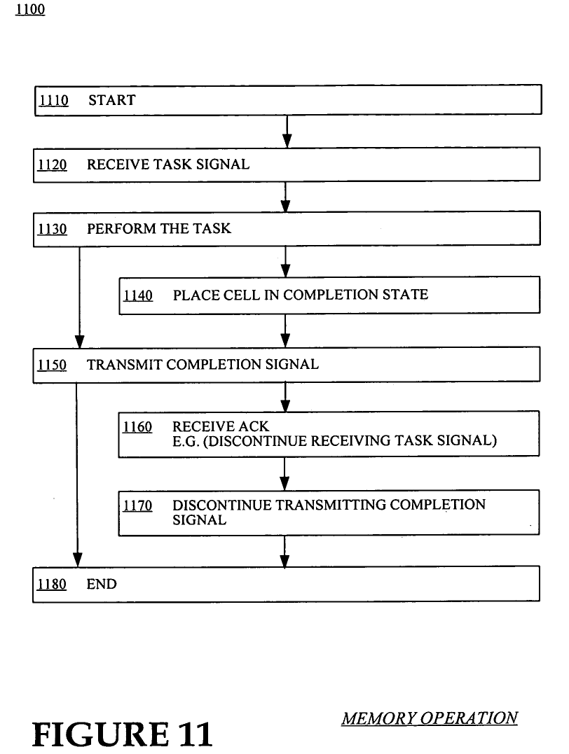

FIG. 11 is flowchart 1100 illustrating a method according to an embodiment of the invention. The method of flowchart 1100 may be practiced by different embodiments of the invention, including but not limited to memory device 100, memory circuits, and so on.

Moving from a START block 1110, at next block 1120 a task signal is received, which relates to a task. The task may be one of programming, program verification, commanding read, initializing, erasing and testing. In one embodiment, the cell includes a pair of transistors, and the task is to substantially equalize a charge stored in the transistors. At next block 1130, the task is performed on at least one cell of the memory circuit.

At next optional block 1140, the cell is placed in a completion state. This may be performed by adjusting an impedance, setting a latch, and so on.

At next block 1150, a completion signal is transmitted in association with performing the task. In some instances, an onset of the completion signal is transmitted while the task signal is being received. In the preferred embodiment, transmitting the completion signal is enabled in response to the cell being in the completion state, if block 1140 has been performed.

At optional next block 1160, acknowledgement signaling (“ACK”) is received, acknowledging that the completion signal has been received. In one embodiment, the acknowledgement signaling is received by discontinuing receiving the task signal.

In one embodiment, acknowledgement signaling is received only in response to an onset of the completion signal. If that is the case, at optional next block 1170, transmitting of the completion signal is discontinued, responsive to receiving the acknowledgement signaling.

At optional next block 1180, the process ends. The process then may be repeated for another task.

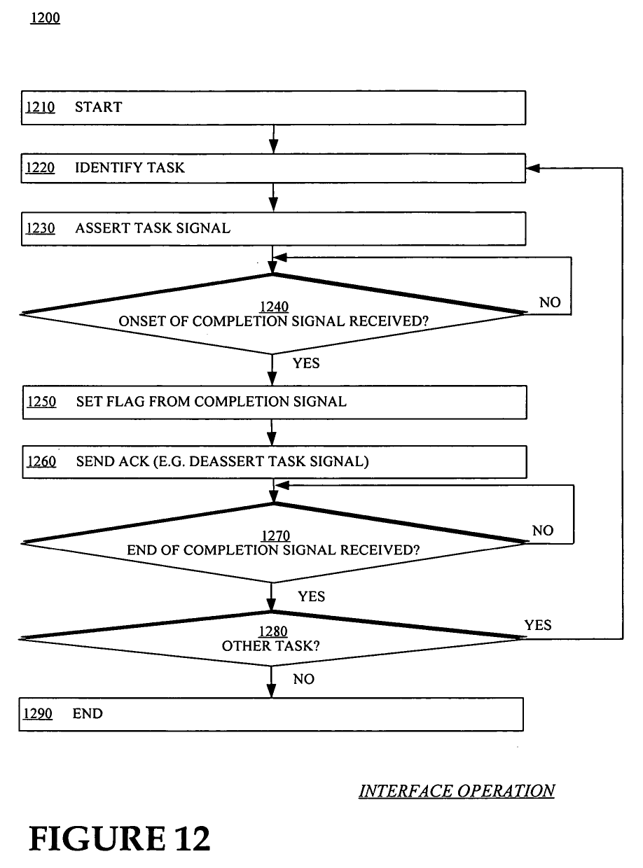

FIG. 12 is flowchart 1200 illustrating a method according to another embodiment of the invention for controlling a memory device. The method of flowchart 1200 may be practiced by different embodiments of the invention, including but not limited to interface 180.

Moving from a START block 1210, a task is identified at next block 1220. At optional next block 1230, a task signal is asserted that relates to a task associated with at least one of the cells of the memory device.

At optional next block 1240, it is determined whether a completion signal has been received in association with performing the task. If not, then the process waits. Further, in one embodiment, the task signal of block 1230 continues to be asserted until an onset of the completion signal is received.

If at block 1240 the completion signal, or its onset, has been received, then at next block 1250 a flag is set. The flag may be a signal in hardware, a software flag, and so on.

At optional next block 1260, acknowledgement signaling is transmitted responsive to receiving the completion signal, or merely its onset, or to the flag being set. In one embodiment, the acknowledgement signaling is implemented by deasserting the task signal of block 1230.

At optional next block 1270, it is determined whether an end of the completion signal has been received. If not, the process optionally waits before asserting another task signal, until the completion signal is no longer received. In other embodiments, the process waits until the flag is set.

If at block 1270 it is determined that the end of the completion signal has been received, then at next block 1280, it is inquired whether there is another task to perform. If yes, the process returns to block 1220. If not, then at next block 1290 the process ends.

Numerous details have been set forth in this description, which is to be taken as a whole, to provide a more thorough understanding of the invention. In other instances, well-known features have not been described in detail, so as to not obscure unnecessarily the invention.

The invention includes combinations and subcombinations of the various elements, features, functions and/or properties disclosed herein. The following claims define certain combinations and subcombinations, which are regarded as novel and non-obvious. Additional claims for other combinations and subcombinations of features, functions, elements and/or properties may be presented in this or a related document.

1. A memory device comprising:
a plurality of memory cells for storing data;
a plurality of completion indicators, each indicator associated with at least one of the memory cells, the completion indicators being set responsive to a task being performed on their associated cells; and
an internal polling mechanism for generating a completion signal when at least some of the completion indicators are set.

2. The device of claim 1, wherein at least some of the memory cells are arranged along an addressable line, and
the completion indicator is associated with the memory cells in the line.

3. The device of claim 2, wherein the line is one of a row and a column.

4. The device of claim 1, wherein one of the cells includes a pair of transistors, and the task is to substantially equalize a charge stored in the transistors.

5. The device of claim 1, wherein a type of the task is one of programming, program verification, commanding read, initialization, erasing and testing.

6. The device of claim 5, wherein the completion signal is the same for two different ones of the task types.

7. The device of claim 6, wherein the polling mechanism is the same for the two different task types.

8. The device of claim 1, wherein at least two of the completion indicators are coupled in series, and
the polling mechanism includes testing a series impedance of the coupled completion indicators.

9. The device of claim 8, wherein the series impedance is tested by one of a voltage and a current.

10. The device of claim 1, wherein at least two of the completion indicators have respective main nodes,
preset voltages are applied to the main nodes responsive to the two completion indicators being set, and
the polling mechanism includes a gate inputting the voltages of the main nodes.

11. The device of claim 10, wherein the preset voltages are logical HI, and the gate is an AND gate.

12. The device of claim 10, wherein the two completion indicators include respective latches to apply the preset voltage at the main node.

13. A memory device comprising:
a core of memory cells for storing data; and
a controller for
receiving a task signal relating to a task,
performing the task on at least one of the cells, and
transmitting a completion signal associated with performing the task.

14. The device of claim 13, wherein one of the cells includes a pair of transistors, and the task is to substantially equalize a charge stored in the transistors.

15. The device of claim 13, wherein a type of the task is one of programming, program verification, commanding read, initialization, erasing and testing.

16. The device of claim 15, wherein the completion signal is the same for two different ones of the task types.

17. The device of claim 13, wherein an onset of the completion signal is transmitted while the task signal is asserted.

18. The device of claim 13, further comprising:
a plurality of completion indicators, each indicator associated with at least one of the memory cells, the completion indicators being set responsive to the task being performed on their associated cells; and
an internal polling mechanism for generating the completion signal when at least some of the completion indicators are set.

19. The device of claim 18, wherein at least some of the memory cells are arranged along an addressable line, and
the completion indicator is associated with the memory cells in the line.

20. The device of claim 19, wherein the line is one of a row and a column.

21. The device of claim 18, wherein at least two of the completion indicators are coupled~in series, and
the polling mechanism is adapted to test a series impedance of the coupled completion indicators.

22. The device of claim 18, wherein at least two of the completion indicators have respective main nodes,
preset voltages are applied to the main nodes responsive to the two completion indicators being set, and
the polling mechanism includes a gate inputting the voltages of the main nodes.

23. The device of claim 22, wherein the preset voltages are logical HI, and the gate is an AND gate.

24. The device of claim 22, wherein the two completion indicators include respective latches to apply the preset voltage at the main node.

25. The device of claim 13, wherein the completion signal is transmitted after performance of the task has been completed.

26. The device of claim 25, wherein the completion signal has a preset duration.

27. The device of claim 25, wherein the controller is further adapted to discontinue transmitting the completion signal responsive to receiving acknowledgement signaling.

28. The device of claim 27, wherein the acknowledgement signaling is received by discontinuing receiving the task signal.

29. A device comprising:
means for receiving in a memory circuit a task signal relating to a task;
means for performing the task on at least one cell of the memory circuit; and
means for transmitting a completion signal associated with performing the task.

30. The device of claim 29, wherein the cell includes a pair of transistors, and
the task is to substantially equalize a charge stored in the transistors.

31. The device of claim 29, wherein a type of the task is one of programming, program verification, commanding read, initialization, erasing and testing.

32. The device of claim 31, wherein the completion signal is the same for two different ones of the task types.

33. The device of claim 29, wherein an onset of the completion signal is transmitted while the task signal is being received.

34. The device of claim 29, further comprising:
means for placing the cell in a completion state responsive to performing the task; and
means for enabling transmitting the completion signal in response to the cell being in the completion state.

35. The device of claim 29, wherein the completion signal is transmitted after performance of the task has been completed.

36. The device of claim 35, wherein the completion signal has a preset duration.

37. The device of claim 35, further comprising:
means for discontinuing transmitting the completion signal responsive to receiving acknowledgement signaling.

38. The device of claim 37, wherein the acknowledgement signaling is received by discontinuing receiving the task signal.

39. A method comprising:
receiving in a memory circuit a task signal relating to a task;
performing the task on at least one cell of the memory circuit; and
transmitting a completion signal associated with performing the task.

40. The method of claim 39, wherein the cell includes a pair of transistors, and the task is to substantially equalize a charge stored in the transistors.

41. The method of claim 39, wherein a type of the task is one of programming, program verification, commanding read, initialization, erasing and testing.

42. The method of claim 41, wherein the completion signal is the same for two different ones of the task types.

43. The method of claim 39, wherein an onset of the completion signal is transmitted while the task signal is being received.

44. The method of claim 39, further comprising:
responsive to performing the task, placing the cell in a completion state; and
enabling transmitting the completion signal in response to the cell being in the completion state.

45. The method of claim 44, wherein the cell is placed in a completion state by adjusting an impedance.

46. The method of claim 44, wherein the cell is placed in a completion state by setting a latch.

47. The method of claim 39, wherein the completion signal is transmitted after performance of the task has been completed.

48. The method of claim 47, wherein the completion signal has a preset duration.

49. The method of claim 47, further comprising:
discontinuing transmitting the completion signal responsive to receiving acknowledgement signaling.

50. The method of claim 49, wherein the acknowledgement signaling is received by discontinuing receiving the task signal.

51. An interface for operating a memory circuit that includes storage cells, the memory capable of performing steps comprising:
asserting a first task signal relating to a first task associated with at least a first one of the cells;
receiving a completion signal associated with performing the first task; and
then asserting a second task signal relating to a second task for at least a second one of the cells responsive to receiving the completion signal.

52. The interface of claim 51, further capable of:
continuing to assert the first task signal until an onset of the completion signal is received.

53. The interface of claim 51, further capable of:
waiting to assert the second task signal until discontinuing receiving the completion signal.

54. The interface of claim 51, further capable of:
transmitting acknowledgement signaling responsive to receiving an onset of the completion signal.

55. The interface of claim 54, wherein the acknowledgement signaling is transmitted by deasserting the first task signal.

56. The interface of claim 51, further capable of:
setting a flag responsive to receiving the completion signal.

57. The interface of claim 56, further capable of:
waiting to assert the second task signal until the flag is set.

58. The interface of claim 56, further capable of:
transmitting acknowledgement signaling responsive to setting the flag.

59. A device for controlling a memory circuit that includes storage cells, comprising:
means for asserting a first task signal relating to a first task associated with at least a first one of the cells;
means for receiving a completion signal associated with performing the first task; and
means for asserting a second task signal relating to a second task for at least a second one of the cells responsive to receiving the completion signal.

60. The device of claim 59, further comprising:
means for continuing to assert the first task signal until an onset of the completion signal is received.

61. The device of claim 59, further comprising:
means for waiting to assert the second task signal until discontinuing receiving the completion signal.

62. The device of claim 59, further comprising:
means for transmitting acknowledgement signaling responsive to receiving an onset of the completion signal.

63. The device of claim 62, wherein the acknowledgement signaling is transmitted by deasserting the first task signal.

64. The device of claim 59, further comprising:
means for setting a flag responsive to receiving the completion signal.

65. The device of claim 64, further comprising:
means for waiting to assert the second task signal until the flag is set.

66. The device of claim 64, further comprising:
means for transmitting acknowledgement signaling responsive to setting the flag.

67. A computer for controlling a memory circuit that includes storage cells comprising: a processor and a storage medium coupled with the processor, the storage medium having instructions stored thereon which, when executed by the processor, result in:
asserting a first task signal relating to a first task associated with at least a first one of the cells;
receiving a completion signal associated with performing the first task; and
then asserting a second task signal relating to a second task for at least a second one of the cells responsive to receiving the completion signal.

68. The computer of claim 67, in which executing the instructions further results in:
continuing to assert the first task signal until an onset of the completion signal is received.

69. The computer of claim 67, in which executing the instructions further results in:
waiting to assert the second task signal until discontinuing receiving the completion signal.

70. The computer of claim 67, in which executing the instructions further results in:
transmitting acknowledgement signaling responsive to receiving an onset of the completion signal.

71. The computer of claim 70, in which the acknowledgement signaling is transmitted by deasserting the first task signal.

72. The computer of claim 67, in which executing the instructions further results in:
setting a flag responsive to receiving the completion signal.

73. The computer of claim 72, in which executing the instructions further results in:
waiting to assert the second task signal until the flag is set.

74. The computer of claim 72, in which executing the instructions further results in:
transmitting acknowledgement signaling responsive to setting the flag.

75. A method for controlling a memory circuit that includes storage cells, comprising:
asserting a first task signal relating to a first task associated with at least a first one of the cells;
receiving a completion signal associated with performing the first task; and
then asserting a second task signal relating to a second task for at least a second one of the cells responsive to receiving the completion signal.

76. The method of claim 75, further comprising:
continuing to assert the first task signal until an onset of the completion signal is received.

77. The method of claim 75, further comprising:
waiting to assert the second task signal until discontinuing receiving the completion signal.

78. The method of claim 75, further comprising:
transmitting acknowledgement signaling responsive to receiving an onset of the completion signal.

79. The method of claim 78, wherein the acknowledgement signaling is transmitted by deasserting the first task signal.

80. The method of claim 75, further comprising:
setting a flag responsive to receiving the completion signal.

81. The method of claim 80, further comprising:
waiting to assert the second task signal until the flag is set.

82. The method of claim 80, further comprising:
transmitting acknowledgement signaling responsive to setting the flag.

83. An RFID tag comprising:
a core of memory cells for storing data; and
a controller for
receiving a first task signal relating to a first task,
performing the first task on at least one of the cells, and
transmitting a completion signal associated with performing the first task.

84. The tag of claim 83, further comprising:
an interface capable of
asserting the first task signal;
receiving the completion signal; and
then asserting a second task signal relating to a second task for at least a second one of the cells responsive to receiving the completion signal.

85. The tag of claim 84, wherein the-interface is further capable of setting a flag responsive to receiving the completion signal.

86. The tag of claim 85, wherein the interface is further capable of waiting to assert the second task signal until the flag is set.

87. The tag of claim 85, wherein the interface is further capable of transmitting acknowledgement signaling responsive to setting the flag.

88. The tag of claim 83, wherein one of the cells includes a pair of transistors, and the first task is to substantially equalize a charge stored in the transistors.

89. The tag of claim 83, wherein a type of the first task is one of programming, program verification, commanding read, initialization, erasing and testing.

90. The tag of claim 83, wherein an onset of the completion signal is transmitted while the first task signal is asserted.

91. The tag of claim 83, further comprising:
a plurality of completion indicators, each indicator associated with at least one of the memory cells, the completion indicators being set responsive to the first task being performed on their associated cells; and
an internal polling mechanism for generating the completion signal when at least some of the completion indicators are set.

92. The tag of claim 91, further comprising:
an interface capable of
asserting the first task signal;
receiving the completion signal; and
then asserting a second task signal relating to a second task for at least a second one of the cells responsive to receiving the completion signal.

93. The tag of claim 91, wherein at least some of the memory cells are arranged along an addressable line, and
the completion indicator is associated with the memory cells in the line.

94. The tag of claim 93, wherein the line is one of a row and a column.

95. The tag of claim 91, wherein at least two of the completion indicators are coupled in series, and
the polling mechanism is adapted to test a series impedance of the coupled completion indicators.

96. The tag of claim 91, wherein at least two of the completion indicators have respective main nodes,
preset voltages are applied to the main nodes responsive to the two completion indicators being set, and
the polling mechanism includes a gate inputting the voltages of the main nodes.

97. The tag of claim 83, wherein the completion signal is transmitted after performance of the first task has been completed.

98. The tag of claim 97, wherein the completion signal has a preset duration.

99. The tag of claim 97, further comprising:
an interface capable of
asserting the first task signal;
receiving the completion signal; and
then asserting a second task signal relating to a second task for at least a second one of the cells responsive to receiving the completion signal.

100. The tag of claim 99, wherein the interface is further capable of continuing to assert the first task signal until an onset of the completion signal is received.

101. The tag of claim 99, wherein the interface is further capable of waiting to assert the second task signal until discontinuing receiving the completion signal.

102. The tag of claim 99, wherein the interface is further capable of transmitting acknowledgement signaling responsive to receiving an onset of the completion signal.

103. The tag of claim 102, wherein the acknowledgement signaling is transmitted by deasserting the first task signal.

104. A RFID tag comprising:
memory cells;
means for asserting a first task signal relating to a first task associated with at least a first one of the cells;
means for performing the task on the first cell; and
means for transmitting a completion signal associated with performing the task.

105. The tag of claim 104, wherein the first cell includes a pair of transistors, and the task is to substantially equalize a charge stored in the transistors.

106. The tag of claim 104, further comprising:
means for continuing to assert the first task signal until an onset of the completion signal is transmitted.

107. The tag of claim 104, further comprising:
means for transmitting acknowledgement signaling responsive to the completion signal.

108. The tag of claim 107, wherein the acknowledgement signaling is transmitted by deasserting the first task signal.

109. The tag of claim 104, further comprising:
means for setting a flag responsive to the completion signal.

110. The tag of claim 109, further comprising:
means for transmitting acknowledgement signaling responsive to setting the flag.

111. The tag of claim 104, further comprising:
means for asserting a second task signal relating to a second task for at least a second one of the cells responsive to the completion signal.

112. The tag of claim 111, further comprising:
means for waiting to assert the second task signal until the completion signal is discontinued.

113. The tag of claim 111, further comprising:
means for setting a flag responsive to the completion signal.

114. The tag of claim 113, further comprising:
means for transmitting acknowledgement signaling responsive to setting the flag.

115. The tag of claim 104, further comprising:
means for placing the first cell in a completion state responsive to performing the task; and
means for enabling transmitting the completion signal in response to the first cell being in the completion state.

116. The tag of claim 115, wherein the first cell is placed in a completion state by adjusting an impedance.

117. The tag of claim 115, wherein the first cell is placed in a completion state by setting a latch.

118. A method for an RFID tag that includes memory cells, comprising:
asserting a first task signal relating to a first task associated with at least a first one of the cells;
performing the task on the first cell; and
transmitting a completion signal associated with performing the task.

119. The method of claim 118, wherein the first cell includes a pair of transistors, and the task is to substantially equalize a charge stored in the transistors.

120. The method of claim 118, further comprising:
continuing to assert the first task signal until an onset of the completion signal is transmitted.

121. The method of claim 118, further comprising:
transmitting acknowledgement signaling responsive to the completion signal.

122. The method of claim 121, wherein the acknowledgement signaling is transmitted by deasserting the first task signal.

123. The method of claim 118, further comprising:
setting a flag responsive to the completion signal.

124. The method of claim 123, further comprising:
transmitting acknowledgement signaling responsive to setting the flag.

125. The method of claim 118, further comprising:
then asserting a second task signal relating to a second task for at least a second one of the cells responsive to the completion signal.

126. The method of claim 125, further comprising:
waiting to assert the second task signal until the completion signal is discontinued.

127. The method of claim 125, further comprising:
setting a flag responsive to the completion signal.

128. The method of claim 127, further comprising:
transmitting acknowledgement signaling responsive to setting the flag.

129. The method of claim 118, further comprising:
responsive to performing the task, placing the first cell in a completion state; and
enabling transmitting the completion signal in response to the first cell being in the completion state.

130. The method of claim 129, wherein the first cell is placed in a completion state by adjusting an impedance.

131. The method of claim 129, wherein the first cell is placed in a completion state by setting a latch.
